(19) United States
(12) Patent Application Publication
(10) Pub. No.: US 2023/0324890 A1
(43) Pub. Date: Oct. 12, 2023

(54) SEMANTIC ANALYSIS METHOD FOR INDUSTRIAL CONTROL PROTOCOL BASED ON INDUSTRIAL SIDE-INFORMATION

(71) Applicant: Guangdong Polytechnic Normal University, Guangzhou City (CN)

(72) Inventors: Jun CAI, Guangzhou City (CN); Weijian ZHONG, Guangzhou City (CN); Jianzhen LUO, Guangzhou City (CN)

(21) Appl. No.: 17/743,986

(22) Filed: May 13, 2022

(30) Foreign Application Priority Data
Apr. 12, 2022 (CN) 2022103807869

(51) Int. Cl. G05B 19/418

(52) U.S. Cl. CPC G05B 19/41835; G05B 2219/31368

(57) ABSTRACT

A semantic analysis method includes gathering patterned side-information in an industrial process and identifying frequency patterns of semantic channels; identifying a set of relevant packets of the semantic channels and deducing locations of the packets where semantics are located; and performing modeling on behavior semantics in the industrial process based on field semantics of the packets and extracting association rules among the semantic channels. The semantic analysis method for the industrial control protocol based on industrial side-information provided by the present invention takes a problem of a difference on response delays of the side-information and information data of protocol packets in an industrial control system into consideration, and analyzes the positions of the semantics of the industrial control protocol, the association rules among the semantics and the like effectively to solve problems in the prior art as the patterned industrial side-information cooperates with the corresponding protocol packets.

### TECHNICAL FIELD

The present invention relates to the technical field of semantic analysis for industrial control protocols, particularly to a semantic analysis method for an industrial control protocol based on industrial side-information.

### BACKGROUND

Industrial Internet has realized close integration of physical world and digital world in industrial field and represented a promising way of industrial operating efficiency and innovation. The system connects devices, data and personnels by utilizing sensors and machine-to-machine learning and network technologies, and allows to managing industrial operations and providing new value-added services by applying analysis tools and network technologies. However, since a lot of non-standard and dedicated industrial control protocols have severely restrained connections and interactions among various manufacturing devices, it has been quite difficult for communication and information exchange of an industrial control system. Protocol semantics include network semantics and field semantics. The network semantics refer to information representing network functions of the basic data units: packet fields of protocol packets, for example, affair IDs and extended domains. The field semantics refer to meaning and knowledge of a part of fields of user data of the protocol packets, which facilitates understanding of terms, concepts and influences. Semantic knowledge of a physical mechanism and a user intention is realized, thereby bringing convenience to decision making. However, due to absence of a semantic knowledge database, it is difficult to deduce semantic information of an industrial control protocol by existing reverse engineering.

### SUMMARY

### (1) The Technical Problems to be Solved

In order to overcome shortcomings in the prior art, the present invention provides a semantic analysis method for the industrial control protocol based on industrial side-information provided by the present invention which takes a problem of a difference on response delays of the side-information and information data of protocol packets in an industrial control system into consideration, and analyzes the positions of the semantics of the industrial control protocol, the association rules among the semantics and the like effectively to solve problems in the prior art that besides packet tracking and protocol programs, reverse engineering seldom pays attention to other assistant information including filed semantic information, and is difficult to provide help for industrial Internet by utilizing the semantic information of the protocol obtained by an existing method.

### (2) Technical Scheme

The present invention provides the following technical scheme: a semantic analysis method for an industrial control protocol based on industrial side-information includes the following steps:
identifying frequent events in each of semantic channels in side-information of an industrial control image;
establishing a packet format reconstruction module of the industrial control protocol, and deducing field locations of packets in each of the semantic channels; and
constructing a semantic behavior analyzer for the industrial control protocol, and deducing various semantic features of the industrial control protocol.

Preferably, the step of identifying the frequent semantic events includes:
identifying each of the semantic channels of a visualized image sequence of the industrial control protocol by utilizing an image residual technique, each of the channels generating a sequence;
generating a unique state label according to a regional feature in each of the images to obtain a semantic label sequence \vec{o}; and
applying a frequent item mining algorithm to the label sequence of the semantic channel so as to identify the frequent events in each of the semantic channels.

Preferably, the semantic channel of the visualized image of the industrial control protocol refers to semantic information displayed on an industrial control panel, for example, temperature information and pressure information.

Preferably, the frequent events of the semantic channel refer to actions through which semantics occur periodically in the industrial process, for example, a series of temperature values 30° C., 29° C., 27° C. and 24° C. represent industrial actions through which temperature is decreased continuously.

Preferably, the packet format reconstruction module of the industrial control protocol includes:
selecting a candidate packet set corresponding to and related to semantics in combination with difference on response delay according to an occurrence time of a frequent semantic event set; and
finding out a protocol packet set relevant to the frequent semantic events by using a sequence alignment-based heuristic algorithm, and deducing the field locations of the packets in each of the semantic channels.

Preferably, the difference on response delay represents a response delay between the gathered industrial control image side-information and the protocol packets corresponding thereto, and the response delay has a certain range [Tₘᵢₙ, Tₘₐₓ]. Therefore, the occurrence times of the candidate packets corresponding to the frequent semantic events can be presented as (tₛₜₐᵣₜ-tₘₐₓ)˜(t_{end}-tₘᵢₙ), where tₛₜₐᵣₜ and t_{end} respectively represent a starting time and an ending time.

Preferably, the candidate packets represent all gathered industrial control protocol packets, and the candidate packet groups represent all candidate packets of one instance meeting the corresponding frequent event conditions in the candidate packets; and the candidate packet set represents a set of the candidate packet groups of all substances of the frequent events.

Preferably, the step of deducing the field locations of the packets in each of the semantic channels includes: finding out a protocol packet set relevant to the frequent semantic events by using a sequence alignment-based heuristic algorithm, and deducing the field locations of the packets in each of the semantic channels.

Preferably, the heuristic algorithm includes: as the traversed object is the protocol bytes of the packets, extracting the same bytes in each of the packets of the candidate packets and generating a sequence to perform the sequence alignment algorithm; if the quantity of the channels included in an algorithm result is equal to the quantity of the states of the frequent events, the semantic represented by the byte being the semantic of the current semantic channel, and otherwise, skipping to a next byte; repeating till traversing all bytes; and finally, obtaining all byte locations representing the semantic.

Preferably, the various semantic features deduced by the semantic behavior analyzer for the industrial control protocol include:
value space deducing, behavior pattern analysis and association rule mining.

Preferably, value space deduction counts a value range and further determines a value type of the field, wherein three types: a constant type, an enumerated value and a real value are considered respectively.

If a certain field only has one observation value, the value type of the field is regarded as the constant type. With respect to some fields, if the quantity of the observation values is greater than 1 but smaller than a given threshold, and the change ratio is smaller than the given threshold, it is regarded that these fields include the values of the enumerated type. Otherwise, the packet type is regarded as the real value type.

Preferably, the behavior pattern represents a special industrial process including actions in a special industrial state.

Preferably, the behavior pattern analysis includes:
performing smoothing processing on the semantic sequence of each of the semantic channels by using an N-neighbor smoothing filter, and then dividing the semantic channel into several sub-paragraphs according to derivative zero points; and
clustering the divided regions by using a hierarchical clustering algorithm based on a dynamic time regulated distance measure according to a profile trend of a curve, fragments in a same cluster being called a basic action of the semantic channel.

Preferably, the behavior pattern analysis includes a concurrence-based association rule and a context-based association rule:
the concurrence-based association rule R_{W} refers to concurrent action sets among the semantic channels and represents spatial dependency. The given threshold γ, the association rule set W and the concurrence-based association rule can be represented as follows:

$${R}_{W} = \{ r : \frac{Sup ( r , W )}{\vert W \vert} \geq γ \}$$

wherein r represents the association rule, and

$$\frac{Sup ( r , W )}{\vert W \vert}$$

represents a support rate of the association rule r.

The context-based association rule captures a relation among actions in adjacent time slots, represented as follows:

u=({a₁^{t},a₂^{t}, . . . }→a^{t+1})
wherein a₁^{t}, a₂^{t}, . . . are actions in the t^{th} time slot and a^{t+1} is an action in the (t+1)^{th} time slot.

Preferably, the context-based association rule with strong relevance is defined as a causal relationship rule. The given threshold γ, the association rule W and the concurrent association rule can be represented as follows:

$${μ}_{W} = \{ u : \frac{Sup ( u , W )}{\vert W \vert} \geq γ \} \\ s . t . \{ \begin{matrix}Prob ( {a}^{t + 1} \vert \{ {a}_{1}^{t} , {a}_{2}^{t} , … \} ) = 1 , \\ Prob ( \{ {a}_{1}^{t} , {a}_{2}^{t} , … \} \vert {a}^{t + 1} ) = 1\end{matrix} .$$

wherein Prob(*) is a probability of an event *.

Compared with the prior art, the present invention provides a semantic analysis method for an industrial control protocol based on industrial side-information with the following beneficial effects:
1. The semantic analysis method for the industrial control protocol based on industrial side-information provided by the present invention takes a problem of a difference on response delays of the side-information and information data of protocol packets in an industrial control system into consideration, and analyzes the positions of the semantics of the industrial control protocol and the association rules among the semantics.

It is to be understood that the above general descriptions and detailed descriptions below are only exemplary and are not intended to limit the present disclosure.

### BRIEF DESCRIPTION OF DRAWINGS

In order to describe the embodiments of the present invention or the technical scheme in the prior art more clearly, brief introduction on drawings needed to be used in the embodiment will be made below. It is obvious that the drawings described below are some embodiments of the present invention, and those skilled in the technical field further can obtain other drawings according to the structures illustrated by the drawings without creative efforts.

FIG. 1 is a method flow chart of an embodiment of a semantic analysis method for an industrial control protocol based on industrial side-information provided by the present invention.

FIG. 2 is a schematic diagram of identifying protocol packets relevant to semantic channels in FIG. 1 by a semantic analysis method for an industrial control protocol based on industrial side-information provided by the present invention.

FIG. 3 is a schematic diagram of deducing locations of semantics in protocol packets in FIG. 1 by a semantic analysis method for an industrial control protocol based on industrial side-information provided by the present invention.

FIG. 4 is behavior semantic modeling in FIG. 1 by a semantic analysis method for an industrial control protocol based on industrial side-information provided by the present invention.

### DETAILED DESCRIPTION OF EMBODIMENTS

The technical solutions in the embodiments of the present invention will be clearly and completely described below in combination with the accompanying drawings in the embodiments of the present invention. The described embodiments are merely a part of, rather than all of, the embodiments of the present invention. Based on the embodiments in the present invention, all other embodiments obtained by those of ordinary skill in the art without making creative efforts fall within the protection scope of the present invention. It is to be understood that on a basis of the embodiments in the present invention, all other embodiments obtained by those skilled in the technical field without creative efforts fall into the scope of protection of the present invention.

It is to be noted that all directional indications (for example, upper, lower, left, right, front, back and the like) in the embodiment of the present invention are merely used for explaining relative position relations, moving conditions and the like among components in a certain special gesture (as shown in the drawings). If the special gesture changes, the directional indications change correspondingly.

In addition, if there are descriptions of ‘first’, ‘second’ and the like in the embodiments of the present invention, ‘one’, ‘second’ and the like are only used for a description purpose rather than being construed to indicate or imply relative importance or implicitly indicate the quantity of indicated technical features. Thus, features defining ‘first’, ‘second’ and the like can expressively or implicitly include at least one feature. In addition, the technical schemes of the embodiments may be combined one another based on implementation by those of ordinary skill in the field. When the technical schemes contradict each other in combination or may not be realized, it is to be considered that there is no combination of the technical schemes, which shall not fall into the protection scope of the present invention.

The side-information refers to any information capable of providing useful information relevant to the industrial control protocol. For example, data gathered from the temperature sensors is conducive to deducing temperature semantics. Therefore, besides the industrial control protocol packets themselves, various sensors such as temperature sensors and pressure sensors can be further used to gather side-information corresponding to the industrial control protocol. These side-information carries semantics of industrial field states, for example, water tank temperature, weight of water in the water tank. Side-information generated by the same semantic forms the semantic channel. The packets carrying information corresponding to the side-information in the semantic channel are called relevant information packets of the semantic channel. Specifically speaking, fields embedded into the relevant packets of the semantic channel data are called relevant fields of the semantic channel.

The present invention provides a semantic analysis method for an industrial control protocol based on industrial side-information. The side-information is used to help looking for protocol locations where the different semantics are and to further help deducing behavior semantics for industrial production, thereby providing a good fundamental preparation for safety analysis such as interconnection and intercommunication among devices and abnormality detection in plants. The present invention is explained by taking the semantic analysis method for an industrial control protocol based on industrial side-information as an example.

### DESCRIPTION OF NUMERALS OF DRAWINGS

| Symbols | Description |
|---|---|
| Eᵢ | Frequent events i |
| C_{E}_{ᵢ}₍ⱼ₎ | Candidate packet groups of the j^{th} instance of the |
| | frequent eventsi |
| Ω_{E}_{₁} | Candidate packet set of the frequent events i |
| G | Quantity of the frequent events |
| Tₘₐₓ | Maximum response delay between the packets |
| | and the side-information |
| Tₘᵢₙ | Minimum response delay between the packets |
| | and the side-information |
| n_{g} | Total quantity of packets in the candidate packet |
| | groups |
| b_{i, j} | The j^{th} packet in the i^{th} packet group |
| ts-i | The ith semantic channel paragraph |

As shown in FIG. 1, a semantic analysis method for an industrial control protocol based on industrial side-information includes the following steps:

S1. frequent events of different semantic channels in side channel picture information are identified.

A human machine interface (HumanMachineInteraction) panel is recorded once per second by a camera. Gathered images are arranged as a time sequence which is represented by χ=X₁, X₂, . . . , X_{T}, wherein T represents a length of the time sequence. If subtraction is performed on each of adjacent images in χ, a difference value region without zero pixels occurs in residual images, which is defined as a sensitive region on the human machine interface panel. All unique sensitive regions [symbol] ={S₁, S₂, . . . , S_{N}} are merged to obtain a sensitive region set of the human machine interface panel, wherein N is a quantity of the sensitive regions. With respect to each of sensitive regions S∈ [symbol] , the content of the region S in each of the images is identified by utilizing a Baidu text Api and is represented as the semantic sequence \vec{o}(S)=(o₁, o₂, . . . , o_{T}).

The events are sub-sequences of the semantic sequences reflecting a basic physical process. For example, in the semantic channel of temperature, a series of temperature values such as 30, 29, 27 and 26 represent an event of a physical process reflecting temperature decrease. The events of the semantic channel S are represented as E^{S}=(e₁^{S}, e₂^{S}, . . . , eₖ^{S}), wherein e₁^{S}, e₂^{S}, . . . , eₖ^{S}∈R(S) is temperature value and each of the events represents the state of the event. As the quantity of elements is k, the events E^{S} are further called events constituted by k states. The frequent events in the semantic sequence represent the frequent and repeated physical processes in the semantic channel. Features of each of sub-processes in a production process are uncovered, which plays an important role in understanding and monitoring the production process. A threshold Γₛᵤₚ and a semantic sequence \vec{o} are given. If the events E occur at least Γₛᵤₚ times in \vec{o}, the events E are regarded as one frequent event in \vec{o}.

In order to extract the frequent events from the semantic sequence, a frequent event discovery algorithm based on an apriori algorithm is designed. The algorithm outputs a frequent event set in the semantic sequence by taking the semantic sequence \vec{o} and the threshold Γₛᵤₚ as input. The algorithm 1 generates an event candidate set with a length of 1 by using all unique elements in \vec{o} as a candidate set F^{c}. Then, the algorithm iteratively performs two steps: (1) a frequent k state event set Fₖ is extracted by selecting a candidate item with frequency not smaller than the given support threshold Γₛᵤₚ; and (2) an event candidate item set F^{c} with a length of (k+1) is generated by connecting every two events in Fₖ. The steps (1) and (2) are repeated till no event candidates with the length of (k+1) can be generated. With any two state events E₁=(e₁¹, e₂¹, . . . eₖ¹) and E₂=(e₁², e₂², . . . eₖ²) with the length of k, if the (k−1)th suffix of E₁ is equal to the (k−1)th prefix of E₂, namely, i=2, 3, . . . , k, the two events with the length of k are connected to generate a candidate (k+1) state event E=(e₁¹, e₂¹, . . . eₖ¹, eₖ²).

The algorithm further considers longer frequent events. For example, the algorithm regards E=abcd rather than E′=bcd because E′ is the sub-event of E. Thus, once the frequent k state event set is calculated, the algorithm deletes all (k−1) state events of the sub-event of any event in Fₖ and stores the rest of events in Fₖ₋₁ in the frequent event set Fₑᵥₑₙₜ.
S2. the candidate protocol packet set corresponding to the frequent events is looked for and the field location of each of semantics is deduced by means of heuristic algorithm based on sequence alignment.
S2.1. identification of the candidate relevant packets

In order to reduce the calculating overhead, in the work, relevant packets of each of the semantic channels are filtered out first and relevant fields are searched in the relevant packets. Under an ideal circumstance, based on temporal correlation with corresponding events, the relevant packets can be identified by matching temporal correlations of the packets with the occurrence times of the events. However, due to randomness of network transmission, for example, time jitters upon arrival of messages, it is hard to determine relevant messages accurately. In order to solve the problem, in the work, a group of candidate relevant packets is determined, and the sizes of the packets are similar to that of the set of the precise relevant packets. The candidate relevant packet group shall completely include the accurate relevant packets but are much smaller than the whole group of packets in size.

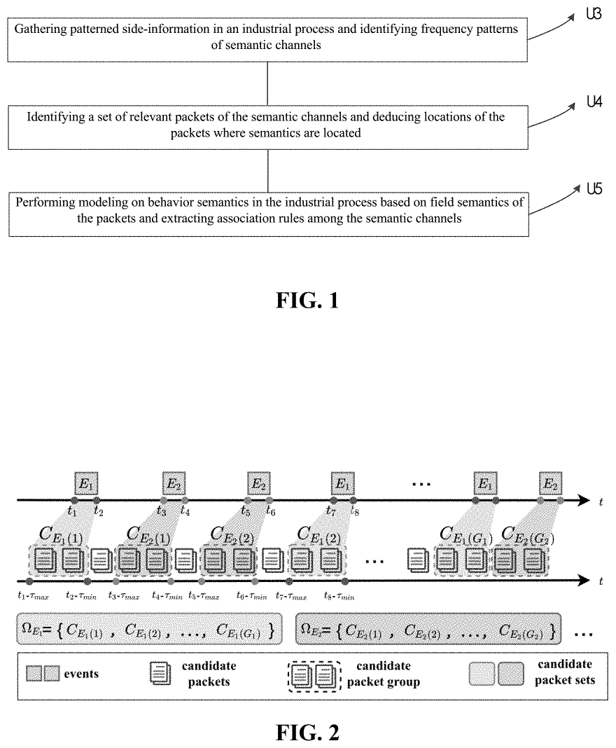

The candidate relevant packets are grouped according to the occurrence times of the events. Generally, there will be a response delay between the time when the relevant packets in one state arrives a gateway and the time when the state is displayed on the human machine interface. The occurrence time of the state e (marked as tₑ) is set to be the time when the state e is displayed on the interface, and the minimum value and the maximum value of the response delay are respectively Tₘᵢₙ and Tₘₐₓ. Then, a series of candidate packets relevant to the state e is a packet list with the arrival times between tₑ-Tₘₐₓ and tₑ-Tₘᵢₙ. The candidate packet group of the event E is marked as C_{E}, which is a set of candidate packets relevant to each state in the event E. It is assumed that the event E is started from the time t₁ and ended at the time t₂, C_{E} is the arrival time between t₁-Tₘₐₓ and t₂-Tₘᵢₙ, as shown in FIG. 2.

With passage of time, the frequent events will occur time and time again. Once the event E occurs, the candidate packet groups relevant to the event E instance will be gathered. The set of all candidate packet groups of the event E is called a candidate packet set which is represented as Ω_{E}={C_{E(1)}, C_{E(2)}, . . . C_{E(G)}}, wherein in the g^{th} group of the C_{E(g)} candidate packet, g=1, 2, . . . , G and G is either the occurrence frequency of the event E or the quantity of the candidate packet groups.
S2.2. identification of semantic locations

Two packets relevant to the event E in the semantic channel are given, and the relevant fields of the semantic channel in the two packets have a same value. Therefore, the relevant packets can be identified by searching for a group of packets with common byte blocks, and these packets always have the same value for all given events. Inspired by this, an event packet association algorithm based on a sequence alignment algorithm is provided to identify the relevant event packets.

First, each byte in the candidate packet in Ω_{E(g)} is traversed to identify the packets including the relevant fields of a target semantic channel. With respect to the gth candidate packet group, the l^{th} byte of each of the packets constitutes the l^{th} byte vector called B_{g}^{l}=(b_{g,1}^{l}, b_{g,2}^{l}, . . . , b_{g,n}_{_{g}}^{l}), wherein b_{g,i}^{l}(i=1, 2, . . . , n_{g}) is the l^{th} byte of the ith packet in the g^{th} candidate packet group C_{E(g)}, and n_{g} is the quantity of the packets in the g^{th} candidate packet group C_{E(g)}.

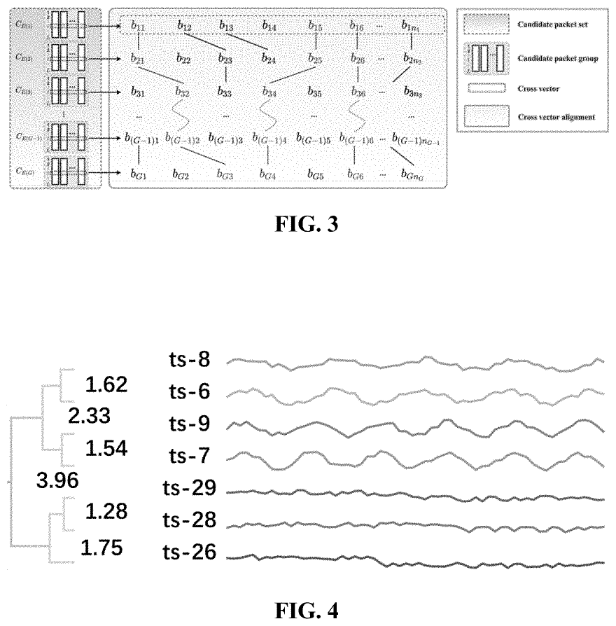

Then, the l^{th} cross vectors of each adjacent group are arranged, namely the g^{th} and the (g+1)^{th} group by means of the sequence alignment algorithm, wherein g=1, 2, . . . , G−1. An alignment result of every adjacent l^{th} cross vector can be represented as a mapping, as shown in FIG. 3, wherein a solid line between two byte vectors represents that the two bytes are aligned (namely, they have the same value). Apparently, if the l^{th} byte is located in the relevant field of the state, the values of the l^{th} byte of the state relevant packets shall use the same value in all candidate packet groups.

Then, when the l^{th} cross vectors of the adjacent group are aligned, bytes of the truly relevant packets will be matched, and these bytes will be connected with the solid line in the result mapping, as shown in FIG. 3. Therefore, a matching result can be tracked and lanes in all cross vectors can be identified, as shown in red lines in FIG. 3, wherein each of red lines represents a state. Meanwhile, all packets corresponding to bytes in the same red line are identified to be relevant to the same state. If the event has k states, there shall be k disjoint lanes. Therefore, the k lanes are looked for by using a recursion-based process and results are stored in mapM. K lines in mapM are searched by using a depth-first recursive algorithm from left to right. If there are no k lines in the map, l is deleted from a candidate index set I.

Finally, with respect to each of k state events E, indexes l of all cross vector maps without k lines. Thus, when all events in E have been processed completely, residual 1 in the index set I are indexes of packet fields relevant to the semantic channels of the events E. Then, continuous indexes in I are connected to index blocks. For example, three continuous indexes l1, l2 and l3 form an index block. The index block represents the packet field relevant to the semantic channel. Accordingly, as a result, all packets on the line k are relevant packets of the target semantic channel.

Generally speaking, it is assumed that only one index block can be found in each of the semantic channels. Otherwise, it is necessary to regard results of other semantic channels as a whole so as to determine correct correlation of the index block. For example, if both a block A and a block B are found in the semantic channel S₁ and only the block B is found in the semantic channel S₂, the block B is used for S₂ and the block A is used for S₁.
S₃. a semantic row of the industrial control protocol is analyzed, and various semantic features of the industrial control protocol are deduced.

In order to analyze the semantic behavior of the industrial control protocol, the value space of each of packet fields is deduced first, and a series of clusters are identified in the value space. Then, behaviors and association rules of the packet fields are analyzed by utilizing the sequence alignment algorithm and the association rule apriori algorithm.

Value Space Deduction:

In the present invention, the value space is deduced and the value type of the packet field is further determined. Three types of field values are considered: constant, enumerated value and real value. The value type of a sub-group field is determined by observing change of the field value. The change rate of the observed field value is defined as a ratio of a unique number. In the work, the value space is deduced and the value type of the sub-group field is further determined. Three types of field values are considered: constant, enumerated value and real value. The value type of a sub-group field is determined by observing change of the field value. The change rate of the observed field value is defined as a unique quantity ratio.

With respect to fields of constant and enumerated types, the value space is a set of the enumerated values. With respect to the type of real value, the value space is represented as the minimum continuous range that covers the observed value completely.

Behavior Pattern Analysis:

To facilitate behavior description, a concept of action is introduced as a basic unit of behavior. The action is defined as a probable value in the packet field, which represents a special state of an industrial device or system. One behavior includes a behavior vector that represents a special industrial process, wherein the behavior pattern represents the constant industrial process. A monitoring system usually needs to analyze the behavior pattern to detect potential process errors so as to guarantee performance and make industrial decisions.

The present invention finds basic actions by using a clustering algorithm. Smoothing processing is performed on the semantic sequence of each of the semantic channels by using an N-neighbor smoothing filter, and then the semantic channel is divided into several sub-paragraphs according to derivative zero points. Then the divided regions are clustered by using a hierarchical clustering algorithm based on a dynamic time regulated distance measure according to a profile trend of a curve. The semantic sequences are grouped to fragments with similar contour shapes by DTW-based clustering, as shown in FIG. 4. Fragments in a same cluster are called a basic action of the semantic channel and are labeled with a unique label. Based on the action unit, the observed semantic sequence can be viewed as an action sequence.

Frequent action sequence is mined by using a location constraining apriori algorithm to extract the behavior pattern. One behavior pattern is represented as a paragraph of continuous action labels that occur frequently and are not superposed in the semantic sequence. The frequent label fragments can be mined by reusing a frequent sequence mining algorithm. Then, with respect to each cluster, a center point is selected as a prototype of the most typical fragment in a representative cluster by using DTW-based k-medoids clustering analysis.

Association Rule Mining:

The association rule is an implied expression which helps display the relation probability among actions and the occurrence frequency of behaviors. The rules facilitate finding of behavioral relevance and relations in the industrial process. There are concurrence-based and context-based association rules that are mined by the apriori algorithm.

The concurrence-based association rule refers to concurrent action sets among the semantic channels and represents spatial dependency. Actions of all semantic channels in special time are represented as snapshots w. The concurrence-based association rule is defined as a group of actions that usually occur in a same snapshot. For example, a₁, a₂, . . . in r={a₁, a₂, . . . } occur in the same snapshot. Then, the frequent action set in the snapshot is extracted by applying the Apriori algorithm. In the algorithm, the support rate of the rule r to a snapshot set W is marked as Sup(r, W), which is a percentage of the snapshot including r. A threshold γ of the support rate is given, and the concurrence-based association rule in the snapshot set W is represented as:

$${R}_{W} = \{ r : \frac{Sup ( r , W )}{\vert W \vert} \geq γ \}$$

wherein r represents the association rule, and

$$\frac{Sup ( r , W )}{\vert W \vert}$$

represents a support rate of the association rule r.

The context-based association rule captures a time relation among actions in adjacent time slots. The context-based association rule is represented as u=({a₁^{t}, a₂^{t}, . . . }→a^{t+1}), wherein a₁^{t}, a₂^{t}, . . . are actions in the t^{th} time slot and a^{t+1} is an action in the (t+1)^{th} time slot. A threshold γ is given, and a concurrence-based association rule set W in the snapshot is represented as:

$${μ}_{W} = \{ u : \frac{Sup ( u , W )}{\vert W \vert} \geq γ \}$$

A causal relationship rule is represented as u^{c}=({a₁^{t}, a₂^{t}, . . . }→a^{t+1}), which is a context-based rule with strong relevance,

$${μ}_{W}^{c} = \{ {u}^{c} : \frac{Sup ( {u}^{c} , W )}{\vert W \vert} \geq γ \} \\ s . t . \{ \begin{matrix}Prob ( {a}^{t + 1} \vert \{ {a}_{1}^{t} , {a}_{2}^{t} , … \} ) = 1 , \\ Prob ( \{ {a}_{1}^{t} , {a}_{2}^{t} , … \} \vert {a}^{t + 1} ) = 1\end{matrix} .$$

wherein Prob(*) is a probability of an event *.

1. A semantic analysis method for an industrial control protocol based on industrial side-information, comprising the following steps:
gathering packet tracking and image-based side-information of the industrial control protocol, and identifying frequent events in each of semantic channels,
wherein the gathering includes:
generating a visualized image sequence of the industrial control protocol for each of the semantic channels by utilizing an image processing technique, and generating a unique state label according to corresponding semantic regional features in images to obtain a semantic sequence,
applying a frequent item mining algorithm to the label sequence of the semantic channel to identify the frequent events in each of the semantic channels,
wherein the applying the frequent item mining algorithm includes:
generating an event candidate set with a length of 1 for the semantic sequence by using the frequent mining algorithm,
extracting a set of events with a length of k by selecting a candidate item with a frequency not less than a given threshold,
generating an event candidate set with a length of k+1 via all events in a connection, and
repeating the extracting and the generating the event candidate set in sequence till no candidate events with the length of k+1 are generated, wherein eventually obtained events are the frequent events, and;
selecting a candidate packet set correspondingly related to semantics according to an occurrence time of a frequent semantic event set;
finding out a protocol packet set relevant to the frequent semantic events by using a sequence alignment-based heuristic algorithm;
deducing a value space of each of fields in a packet format; and
determining semantic features including frequent modes and association rules among the fields.

2. (canceled)

3. (canceled)

4. (canceled)

5. (canceled)

6. The semantic analysis method for an industrial control protocol based on industrial side-information according to claim 1, wherein a constraint condition of identifying the frequent events comprises:
with respect to any two events with the length of k, connecting the two events with the length of k to an event with the length of k+1 if the succeeding k−1 states of one of the two events are identical to the preceding k−1 states of the other of the two events; and
with respect to any two events with different lengths, deleting the event with the smaller length if the event with the smaller length is a sub-event of the event with the larger length.

7. The semantic analysis method for an industrial control protocol based on industrial side-information according to claim 3, wherein the method for looking for the semantic candidate packet comprises:
setting a maximum value Tₘₐₓ and a minimum value Tₘᵢₙ of a difference value on response delays of the side channel data and the data of the protocol packets;
extracting occurrence times (tᵢ-tₘₐₓ)˜(tⱼ-tₘᵢₙ) of the candidate packet groups C_{E} corresponding to the events from the candidate packets according to the occurrence times tᵢ˜tⱼ of the events E; and
constituting a candidate packet set Ω_{E}={C_{E(1)}, C_{E(2)}, . . . , C_{E(G)}} of the events by the candidate packet groups of all same events, wherein G is a quantity of the candidate packet groups of events E.

8. The semantic analysis method for an industrial control protocol based on industrial side-information according to claim 3, wherein the method for deducing the field locations of the semantic channels in the packets comprises:
extracting a first byte value of each of the candidate packet groups of the same event to constitute a byte sequence set; and
traversing the byte sequence set subjected to the sequence alignment algorithm to look for channels with a length of G, and with respect to the events with the length of k, if there are k channels with the length of G, regarding that the current byte represents semantic represented by the current event; and if the quantity of the channels with the length of G is not equal to k, extracting a next byte value, and repeating the step till extracting the last byte.

9. The semantic analysis method for an industrial control protocol based on industrial side-information according to claim 3, wherein the step of analyzing the behavior semantic comprises:
deducing a value range and further determining a value type of the field, wherein three types: a constant value, an enumerated value and a real value are considered respectively.
